(19) United States
(12) Patent Application Publication
(10) Pub. No.: US 2008/0216817 A1
(43) Pub. Date: Sep. 11, 2008

(54) Charbroiler with Even Heat Distribution

(76) Inventor: Christian M. Yungbluth, Charlotte, NC (US)

Correspondence Address: THOMPSON HINE LLP;Intellectual Property Group, P.O Box 8801, DAYTON, OH, 45401-8801, US

(21) Appl. No.: 12/042,735

(22) Filed: Mar. 5, 2008

Related U.S. Application Data
(60) Provisional application No. 60/893,147, filed on Mar. 6, 2007.
(60) Provisional application No. 60/974,887, filed on Sep. 25, 2007.

(51) Int. Cl. A47J 37/06

(52) U.S. Cl. 126/41 R

(57) ABSTRACT

A gas-fired charbroiler includes one or more features to provide more even heat distribution on the cooking surface. Orifices that feed respective burners can have different sizes. A baffle structure may be included on the sides of the burners. Burners may be configured such that burner port flow area per unit length varies.

### CROSS-REFERENCES

This application claims the benefit of U.S. provisional application Ser. No. 60/893,147 filed Mar. 6, 2007 and U.S. provisional application Ser. No. 60/974,887 filed Sep. 25, 2007, the entirety of each of which is incorporated herein by reference.

### TECHNICAL FIELD

This application relates generally to gas-fired cooking apparatus and, more particularly, to gas-fired charbroilers.

### BACKGROUND

Charbroilers used in commercial kitchens typically include multiple burners distributed across a width of a cooking area, which may be defined by a series of grates on which food is to be cooked. The flames from each burner heat a radiant emitter that in turn heats the underside of the grated. The number of burners, radiant emitters and grates typically varies based upon overall width of the set cooking area. A common issue with such charbroilers is a lack of evenness in the heat distribution over the grating surface, resulting in relative hot spots and cool spots that make achieving a consistent cooking result more difficult.

It would be desirable to provide a charbroiler configured to facilitate even heat distribution over the grating surface.

### SUMMARY

In one aspect, a gas-fired cooking apparatus includes a cooking area, a gas manifold and a plurality of gas-fired burners positioned for heating the cooking area and distributed across a width of the cooking area. Each gas-fired burner is connected to receive gas from the gas manifold via a respective orifice. At least two of the orifices are of different sizes.

In another aspect, a gas-fired charbroiler apparatus includes a cooking area defined by a grate assembly and a plurality of gas-fired burners positioned to heat the grate assembly and distributed across a width of the cooking area. A baffle structure is positioned between adjacent gas-fired burners for reducing pluming during combustion, each baffle structure is a substantially vertical baffle wall extending from a lower edge of a deflector below the burner upward to a position immediately adjacent an underside of the grate assembly.

In a further aspect, a gas-fired cooking apparatus includes a cooking area and a plurality of gas-fired burners positioned above or below the cooking area and distributed across a width of the cooking area. Each gas-fired burner is elongated and includes burner ports. Burner port flow area per unit of burner length varies for at least some of the burners.

### BRIEF DESCRIPTION OF THE DRAWINGS

FIG. 1 illustrates an exemplary charbroiler;

FIG. 2 illustrates an alternative countertop styles charbroiler arrangement;

FIG. 3 is a schematic front elevation of the burner arrangement of the charbroiler of FIG. 1;

FIG. 4 illustrates a manifold and burner assembly arrangement for the charbroiler of FIG. 1;

FIG. 5 is a valve hood cross-section;

FIG. 6 depicts a prior art burner port configuration;

FIG. 7 depicts a burner port distribution that provides a varied burner port area per unit length.

### DETAILED DESCRIPTION

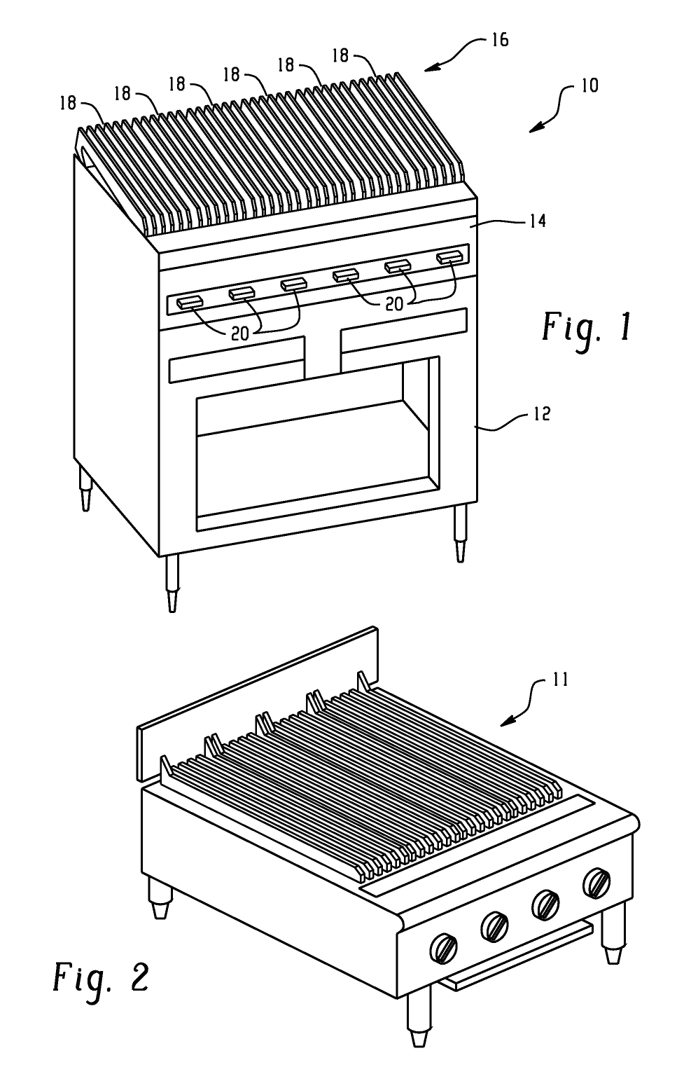

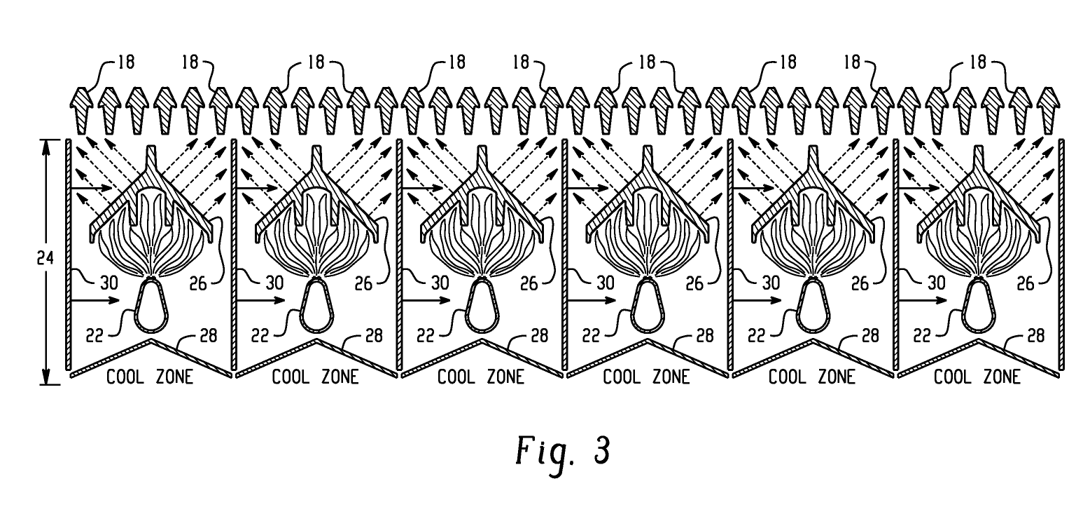

Referring to FIGS. 1 and 3, a gas-fired charbroiler 10 includes a lower base 12 and an upper cooking section 14. The cooking section includes a cooking area 16 defined by a grate assembly in the form of a plurality of grate members 18. Six grate members are shown in the illustrated embodiment. A front portion of the cooking section includes valve control knobs 20 for controlling delivery of combustible gas (e.g., natural gas or propane) to burners 22 within a burner box region 24 of the unit, which is immediately below the grates 18. In the illustrated embodiment a single burner is associated with each distinct grate member 18, but variations are possible. Moreover, the number of grate members and burner arrangements can vary. For example, charbroilers including anywhere from 3 to 13 or more burners distributed across a width of the cooking area may be constructed. It is also recognized that the overall configuration of the charbroiler can vary. For example, the charbroiler could take the form of a countertop style unit 11 as shown in FIG. 2. Additionally, burners could be positioned above the cooking area in some charbroiler configurations.

Referring to FIG. 3, a radiant structure 26 is positioned above each burner 20 such that the burner heats the radiant structure 26 and the grates 18 are heated primarily by radiant heat emitted by the radiant structures 26. A heat deflector 28 is positioned below each burner as well. Notably, baffle structures 30 are positioned between each to the sides of each burner 20. The illustrated baffle structures are substantially vertical baffle walls that extend from immediately adjacent the lower edges of the deflectors 28 upward to locations immediately adjacent the underside of the grates 18. As used in this application, the term “immediately adjacent” means within a distance 0.20 inches or less. By having the baffle walls extend as described above, each burner is effectively contained within its own baffle box, which reduces pluming and provides for more uniform heat distribution to the grates.

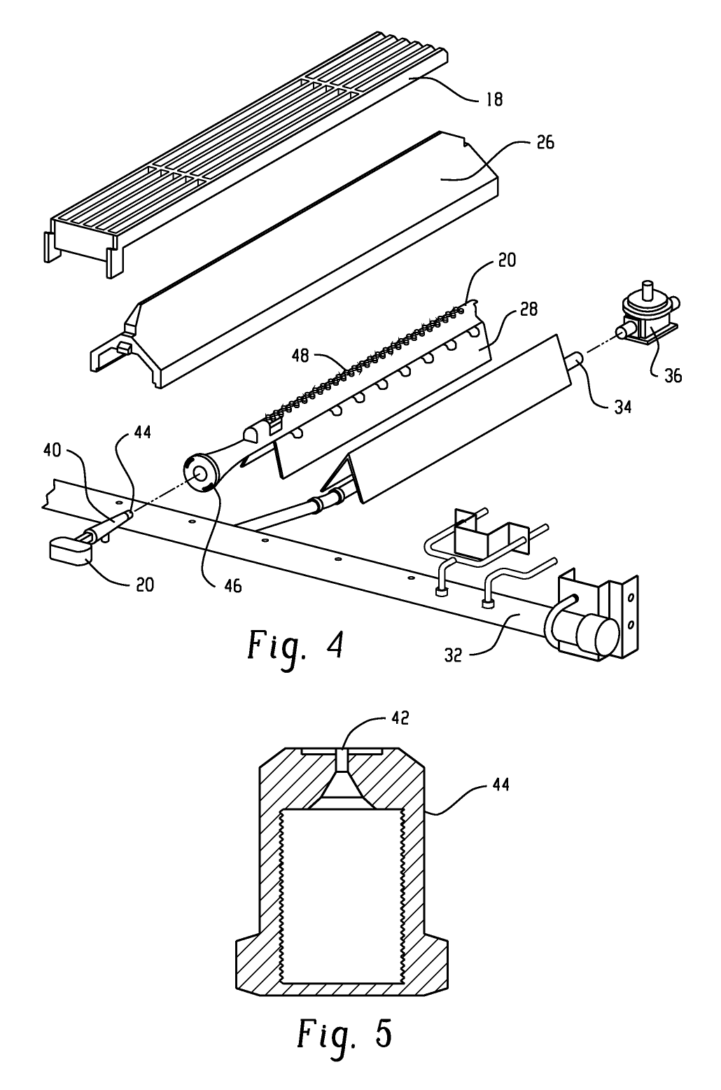

Referring to the exemplary assembly schematic of FIG. 4, each burner 20 may be connected to a common gas manifold 32. Variations on such an assembly are contemplated. A pipe feed 34 running from a pressure regulator 36 to the gas manifold is also shown. The control knobs 20 control flow through valve bodies 40. The flow limit of each valve is set by the size of an orifice 42 (FIG. 5) of a valve hood 44 that screws onto the end of the valve body. In one implementation, rather than using the same orifice size for each burner, different orifice sizes are used on at least one or more of the burners in order to achieve a more even temperature distribution to the grates. In order to uniformly illuminate, or in this case radiate with heat, a flat surface with multiple sources (i.e., multiple burners), the sources themselves should be asymmetric. Providing different orifice sizes to deliver combustible gas to burners of common configuration facilitates that asymmetry. Where each burner is of a common configuration, as is typical, one or more of the outer burners (e.g., the left most burner and/or the right most burner) will generally have an associated feed orifice size that is larger than that of one or more of the intermediate burners. However, variations are possible.

For any given charbroiler configuration, suitable orifice sizes for each of the multiple burners of the configuration can be set by running through a testing procedure. Specifically, ASTM Broiler Test Standard—F1695-03, which provides a procedure for evaluating temperature distribution. By repeatedly running through this procedure and selectively varying and setting orifice sizes for each of the burners, an appropriate orifice size arrangement can be achieved for any given charbroiler so as to provide a heat distribution that is desired. Given the different characteristics of propane and natural gas, the orifice size establishment procedure may be conducted using natural gas in one case, and propane in another case, resulting in different orifice sizing as between a unit designated a natural gas unit and a unit designated a propane unit. In addition, the procedure may be conducted at a known elevation, and orifice size later scaled based upon intended elevation for a given unit.

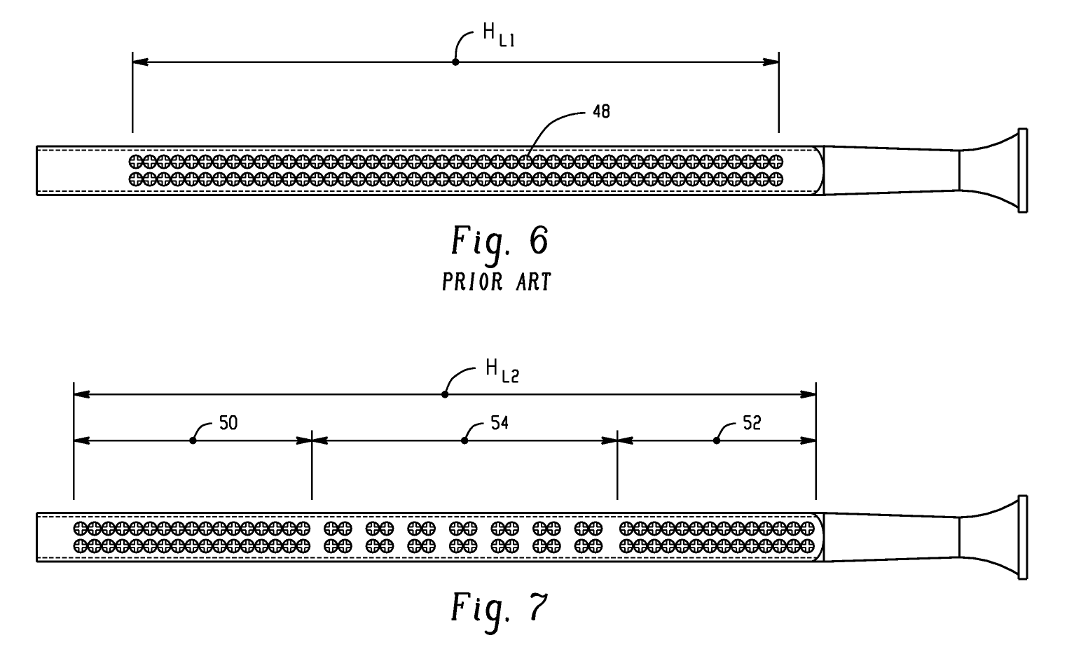

Referring again to FIG. 4, each burner 20 includes a shutter arrangement 46 that enables control of the percentage of primary air that goes through the shutter and secondary air that surrounds the burner. Suitable results are typically achieved with 60% primary air and 40% secondary air, but variations are possible. The illustrated burner 20 includes a uniform distribution of burner ports 48 along its heating length. This even distribution is known in the prior art and readily seen in FIG. 6. As used herein the term “heating length” means a length defined by the distance from the location of the burner port closest to the input end of the burner to the location of the burner port furthest from the input end of the burner. The heating length H_{L1} for the illustrated burner of FIG. 6 is shown.

In another embodiment, even heat distribution is facilitated by use of burners that are configured such that configured such that burner port flow area per unit of burner length varies along a heating length of the burner. Referring to the exemplary burner of FIG. 7, it can be seen that the overall heating length H_{L2} of the burner has been increased as compared to the prior art burner of FIG. 6. Moreover, distinct port arrangement have been defined in different burner segments. Specifically, burner end segments 50 and 52 have a higher density of burner ports than intermediate segment 54. Where the burner ports are all of a common size, this arrangement provides for more gas flow through, and therefore more combustion in the region of the burner end segments 50 and 52 than in the region of intermediate segment 54. Different techniques may be used to achieve a similar result, as by using the same number, but different size ports along the different segments. As with the case of valve hood orifice size selection, for any given charbroiler repeated testing and modification of burner flow area variations using the ASTM procedure can be used to select the burner configuration that gives a desired heat distribution characteristic.

In one implementation, the burner flow area per unit length for end segments 50 and 52 is the same (though they could be different) and the burner flow are per unit length of the intermediate segment is between fifty and seventy percent of that of the end segments. However, variations are possible. The intermediate segment may form thirty to fifty percent of the overall heating length of the burner, but variations are possible. It is also recognized that more than three distinct burner segments may be defined by the burner port flow area variations.

It is to be clearly understood that the above description is intended by way of illustration and example only, is not intended to be taken by way of limitation, and that various changes and modifications are possible.

What is claimed is:

1. A gas-fired cooking apparatus, comprising:
a cooking area;
a gas manifold;
a plurality of gas-fired burners positioned for heating the cooking area and distributed across a width of the cooking area, each gas-fired burner connected to receive gas from the gas manifold via a respective orifice, wherein at least two of the orifices are of different sizes.

2. The apparatus of claim 1 wherein each orifice is associated with a respective valve.

3. The apparatus of claim 2 wherein the gas-fired cooking apparatus is a charbroiler, and the gas-fired burners are located below a grate assembly that defines the cooking area.

4. The apparatus of claim 3 wherein a radiant structure is positioned between each gas-fired burner and the grate assembly.

5. The apparatus of claim 4 wherein a deflector is positioned below each gas-fired burner, a baffle structure is positioned between adjacent gas-fired burners for reducing pluming during combustion, each baffle structure is a substantially vertical baffle wall extending from a lower edge of the deflector upward to a location immediately adjacent an underside of the grate assembly.

6. The apparatus of claim 5 wherein each gas-fired burner is elongated and includes burner ports, the burner ports are sized and positioned such that gas flow from a first burner end segment and gas flow from a second burner end segment is greater than gas flow from an intermediate burner segment.

7. The apparatus of claim 6 wherein a number of burner ports per unit length in the first burner end segment is greater than a number of burner ports per unit length in the intermediate burner segment, and a number of burner ports per unit length in the second burner end segment is greater than the number of burner ports per unit length in the intermediate burner segment.

8. The apparatus of claim 1 wherein the plurality of gas-fired burners are of a common size and configuration, each gas-fired burner is elongated and includes burner ports, burner port flow area per unit of burner length varies.

9. The apparatus of claim 8, wherein the burner ports are sized and positioned such that gas flow from a first burner end segment and gas flow from a second burner end segment is greater than gas flow from an intermediate burner segment.

10. A gas-fired charbroiler apparatus, comprising:
a cooking area defined by a grate assembly;
a plurality of gas-fired burners positioned to heat the grate assembly and distributed across a width of the cooking area;
a baffle structure is positioned between adjacent gas-fired burners for reducing pluming during combustion, each baffle structure is a substantially vertical baffle wall extending from a lower edge of a deflector below the burner upward to a position immediately adjacent an underside of the grate assembly.

11. The apparatus of claim 10 wherein a radiant structure is positioned between each gas-fired burner and the grate assembly.

12. The apparatus of claim 11 wherein each gas-fired burner is elongated and includes burner ports, burner port flow area per unit of burner length varies.

13. The apparatus of claim 12, wherein the burner ports are sized and positioned such that gas flow from a first burner end segment and gas flow from a second burner end segment is greater than gas flow from an intermediate burner segment.

14. A gas-fired cooking apparatus, comprising:
a cooking area;
a plurality of gas-fired burners positioned above or below the cooking area and distributed across a width of the cooking area, each gas-fired burner is elongated and includes burner ports, at least one of the gas-fired burners is configured such that burner port flow area per unit of burner length varies along a heating length of the gas-fired burner.

15. The apparatus of claim 14 wherein an intermediate segment of the heating length has a lower burner port flow area per unit length than both a first end segment of the heating length and a second end segment of the heating length.

16. The apparatus of claim 14, wherein the burner ports are sized and positioned such that gas flow from a first burner end segment and gas flow from a second burner end segment is greater than gas flow from an intermediate burner segment.

17. The apparatus of claim 16 wherein a number of burner ports per unit length in the first burner end segment is greater than a number of burner ports per unit length in the intermediate burner segment, and a number of burner ports per unit length in the second burner end segment is greater than the number of burner ports per unit length in the intermediate burner segment.

18. The apparatus of claim 17 wherein the gas-fired cooking apparatus is a charbroiler, and the gas-fired burners are located below a grate assembly that defines the cooking area, a radiant structure is positioned between each gas-fired burner and the grate assembly.

19. The apparatus of claim 18 wherein each gas-fired burner is connected to receive gas from a gas manifold via a respective orifice, wherein at least two of the orifices are of different sizes.

20. The apparatus of claim 19 wherein each orifice is associated with a respective valve.

21. The apparatus of claim 20 wherein a deflector is positioned below each gas-fired burner, a baffle structure is positioned between adjacent gas-fired burners for reducing pluming during combustion, each baffle structure is a substantially vertical baffle wall extending from a lower edge of the deflector upward to a location immediately adjacent an underside of the grate assembly.
